(19) United States
(12) Patent Application Publication
(10) Pub. No.: US 2024/0079642 A1
(43) Pub. Date: Mar. 7, 2024

(54) METHOD FOR PREPARING SOLID ELECTROLYTE, SOLID ELECTROLYTE PREPARED THEREBY, AND ALL-SOLID-STATE BATTERY COMPRISING SAME

(71) Applicant: KOREA ELECTROTECHNOLOGY RESEARCH INSTITUTE, Gyeongsangnam-do (KR)

(72) Inventors: Yoon Cheol HA, Gyeongsangnam-do (KR); Sang Min LEE, Gyeongsangnam-do (KR); Byung Gon KIM, Gyeongsangnam-do (KR); Gum Jae PARK, Gyeongsangnam-do (KR); Jun Woo PARK, Gyeongsangnam-do (KR); Jun Ho PARK, Seoul (KR); Ji Hyun YU, Gyeongsangnam-do (KR); Won Jae LEE, Gyeongsangnam-do (KR); You Jin LEE, Gyeongsangnam-do (KR); Hae Young CHOI, Gyeongsangnam-do (KR)

(73) Assignee: KOREA ELECTROTECHNOLOGY RESEARCH INSTITUTE, Gyeongsangnam-do (KR)

(21) Appl. No.: 18/272,597

(22) PCT Filed: Jan. 11, 2022
(86) PCT No.: PCT/KR2022/000464

§ 371 Date: Jul. 17, 2023

(30) Foreign Application Priority Data
Jan. 15, 2021 (KR) 10-2021-0006268
Apr. 30, 2021 (KR) 10-2021-0056907

(51) Int. Cl. H01M 10/0562

(52) U.S. Cl. CPC H01M 10/0562; H01M 2300/0068; H01M 2300/0085

(57) ABSTRACT

The present invention relates to a method for preparing an alkali metal ion conductive chalcogenide-based solid electrolyte, a solid electrolyte prepared thereby, and an all-solid-state battery comprising the same. The technical gist of the present invention is to involve: reacting, in a polar aprotic solvent, alkali metal ion conductive chalcogenide-based solid electrolyte raw materials including an alkali metal-containing material, a transfer catalyst that ionizes an alkali metal and transfers ions and electrons, a chalcogen element, a compound of one or more elements of Groups 2 to 15 and Group 17 of the periodic table, to prepare a precursor solution in which an alkali metal ion conductive chalcogenide-based solid electrolyte precursor is present in a suspended state, a dissolved state, or a partially suspended and partially dissolved state, via an alkali metal polychalcogenide produced by the transfer of the ions and electrons from the alkali metal-containing material to the chalcogen element; recovering the alkali metal ion conductive chalcogenide-based solid electrolyte precursor as a powder from the precursor solution; and heat treating the alkali metal ion conductive chalcogenide-based solid electrolyte precursor powder.

### TECHNICAL FIELD

The present invention relates to a method for preparing an alkali metal ion conductive chalcogenide-based solid electrolyte, a solid electrolyte prepared thereby, and an all-solid-state battery comprising the same.

### DESCRIPTION OF RELATED ART

Nowadays, rechargeable batteries are widely used in large devices such as automobiles and power storage systems as well as in small devices such as cellular phones, camcorders, and laptops. As the range of applications of rechargeable batteries expands, the demand for improved safety and higher performance for rechargeable batteries is increasing.

Compared to nickel-manganese batteries or nickel-cadmium batteries, lithium secondary batteries have the advantage of high energy density and large capacity per unit area. However, safety issues such as electrolyte leakage and a risk of fire are constantly being raised about lithium secondary batteries because lithium secondary batteries mostly use a liquid electrolyte based on an organic solvent. To address such safety issues, interest in all-solid-state batteries using solid electrolytes rather than liquid electrolytes is increasing.

Solid-state electrolytes are generally categorized into oxide, sulfide, and polymer types. Lithium-ion conductive sulfide solid-state electrolytes have high lithium-ion conductivity equivalent to that of liquid electrolytes and are advantageous in terms of interfacial contact between powder particles or with active materials due to their high ductility. Therefore, lithium-ion conductive sulfide solid-state electrolytes are actively used in the development of all-solid-state batteries.

Alkali metal ion conductive chalcogenide-based solid electrolytes, including lithium-ion conductive sulfide solid electrolytes, can be prepared by dry synthesis or wet synthesis. Dry synthesis methods include a solid-phase reaction method involving raw material mixing, pelletizing, heat treatment, grinding, pelletizing, and heat treatment, and a mechanical milling method involving dry/wet ball milling and heat treatment. The wet synthesis methods include a suspension method, a dissolution method, and a hybrid method using both. In the suspension method, solid electrolyte raw materials are dispersed/reacted in a polar aprotic solvent to form a particulate solid electrolyte precursor powder in a solvent, followed by powder recovery and heat treatment. In the dissolution method, raw materials are completely dissolved as precursors in a polar protic solvent, a polar aprotic solvent, or a mixed solution thereof, followed by drying and heat treatment. In the hybrid method, precursors are partly dissolved and partly prepared as powders, and the mixture of the precursors is subjected to processes such as drying and heat treatment.

In a representative example of the suspension method, lithium sulfide (Li₂S) and phosphorous pentoxide (P₂S₅) are reacted in a solvent such as tetrahydrofuran (THF) or acetonitrile (ACN) to obtain precursor suspensions such as Li₃PS₄·3THF or Li₃PS₄·2ACN. The precursor suspension is then recovered as a powder. The powder is dried and heat-treated to obtain a solid electrolyte powder of Li₃PS₄.

While the suspension method has the advantage of recovering particulate solid electrolyte precursors, it has the disadvantages of low composition uniformity of the solid electrolyte precursors formed through particle-particle reaction of the raw materials, slow production rate, limited types of solid electrolytes that can be prepared in this way, and relatively low ionic conductivity (<1 mS/cm).

In a representative example of the dissolution method, Li₂S and P₂S₅ are reacted in THF to prepare Li₃PS₄·3THF precursor, and then this precursor or solution is mixed with Li₂S and a lithium halogen compound (LiX, X═F, Cl, Br, I) in ethanol to prepare Li₆PS₅X precursor that is in a fully dissolved state. The solvent is then evaporated to obtain a powder, and the powder is dried and heat-treated to obtain a solid electrolyte powder of Li₆PS₅X. For a lithium argyrodite structure, represented by Li₆PS₅X, it has been reported that solid electrolytes with ionic conductivities above 1 mS/cm can be synthesized through composition control. However, this dissolution method has the disadvantages of requiring an additional process of evaporating the solvent to recover the precursor powder from the fully dissolved solution or a process of precipitating powder in a non-polar solvent. In addition to the dissolution method has difficulty in controlling the particle size of the recovered powder and difficulty in separating and reusing solvents when a mixed solvent is used. Therefore, it is difficult to apply the dissolution method to the mass production of solid electrolytes.

In a representative example of the hybrid method using both the suspension and dissolution methods, Li₂S and P₂S₅ are reacted in ACN in a ratio of 7:3 to obtain Li₃PS₄·2ACN that is partially prepared in a dissolved state and is partially prepared in a suspension state. Subsequently, the solvent is evaporated to recover a powder, and the powder is dried and heat-treated to obtain a solid electrolyte powder of Li₇P₃S₁₁. This method also has the disadvantage of requiring an additional process of evaporating the solvent to recover the precursor powder from a mixed solution in which a dissolved phase and a suspension phase are mixed, and has difficulty in controlling the particle size of the recovered powder. Due to these problems, this method is difficult to apply to the mass production of solid electrolytes.

On the other hand, to date, most of the wet solid-state electrolyte synthesis methods use Li₂S as a raw material. Li₂S powder has the disadvantage of a slow reaction rate because the reaction of 3Li₂S+P₂S₅→2Li₃PS₄, which is the core reaction of most wet synthesis methods, proceeds inward with Li₂S as the core and Li₃PS₄ as the shell. The reaction is highly affected by the purity, particle size, oxidation, etc. of Li₂S. In addition, it is difficult to prepare Li₂S because there is the safety issue of using a large amount of H₂S, which is a harmful gas, for the synthesis of Li₂S, and additional costs are required for purification of Li₂S. In addition, there is difficulty in storage because Li₂S needs to be stored in an inert gas, and commercially available battery-grade, high-purity Li₂S powders can cost about $10,000 per kilogram, making Li₂S-based solid-state electrolyte materials uncompetitive.

Therefore, for the large-scale production of alkali metal ion conductive chalcogenide-based solid electrolytes, required is a new preparation method that does not use high-purity Li₂S, Na₂S, or K₂S as a raw material, can be completely performed in one pot in a single solvent so that precursors and solvents can be recovered and reused, and can produce a solid electrolyte with ionic conductivity equivalent to that of electrolytes that are produced by conventional synthesis methods.

### SUMMARY

### Technical Problem

The present invention has been made to solve the problems occurring in the related art, and the technical problem to be solved by the invention is to provide a wet-type alkali metal ion conductive chalcogenide-based solid electrolyte preparation method that enables low-cost mass production of an alkali metal ion conductive chalcogenide-based solid electrolyte, to provide a solid electrolyte prepared thereby, and to provide an all-solid-state battery including the solid electrolyte.

### Technical Solution

In order to solve the technical problem, the present invention provides an alkali metal ion conductive chalcogenide-based solid electrolyte preparation method including: reacting, in a polar aprotic solvent, alkali metal ion conductive chalcogenide-based solid electrolyte raw materials including an alkali metal-containing material, a transfer catalyst that ionizes an alkali metal and transfers ions and electrons, a chalcogen element, a compound of one or more elements of Groups 2 to 15 and Group 17 of the periodic table, to prepare a precursor solution in which an alkali metal ion conductive chalcogenide-based solid electrolyte precursor is present in a suspended state, a dissolved state, or a partially suspended and partially dissolved state, via an alkali metal polychalcogenide produced by the transfer of the ions and electrons from the alkali metal-containing material to the chalcogen element; recovering the alkali metal ion conductive chalcogenide-based solid electrolyte precursor in a powder form from the precursor solution; and heat treating the alkali metal ion conductive chalcogenide-based solid electrolyte precursor in a powder form.

In the present invention, the alkali metal-containing material may be selected from the group consisting of an alkali metal, an alkali metal-transfer catalyst radical solution formed by reacting the alkali metal with the transfer catalyst in the polar aprotic solvent, and mixtures thereof.

In the present invention, the alkali metal ion conductive chalcogenide-based solid electrolyte is represented by the following Chemical Formula 1:

(A⁺)ₐ(Bⁿ⁺)_{b}(X²⁻)ₓ(Y⁻)_{y} [Chemical Formula 1]

In Chemical Formula 1, A is one or more elements among Li, Na, and K; B is one or more elements of Groups 2 through 15 of the periodic table; X is one or more elements among S, Se, and Te, or a mixture of the one or more elements and O; Y is one or more elements or compounds among F, Cl, Br, I, CN, OCN, SCN, and N₃; a+n*b−2*x−y=0; a>0, x>0; and at least one of b and y is a value that satisfies >0.

In the present invention, in Chemical Formula 1, A=Li; B═P; X═S; Y=one or more halogen elements among F, Cl, Br, and I; a=7−y, b=1, x=6−y, and 0.1≤y≤2; and an azirodite crystal structure of space group F-43m accounts for 50-100 wt %.

In the present invention, when preparing the precursor solution, alkali metal-transfer catalyst radicals produced by the reaction of the alkali metal-containing material and the transfer catalyst transfer the alkali metal ions and electrons to the chalcogen element to form an alkali metal polychalcogenide that is present in a dissolved state or a dispersed state, and the polychalcogenide reacts or mixes with the element B, the element Y, or a compound thereof, so that the precursor solution in which the alkali metal ion conductive chalcogenide-based solid electrolyte precursor is present in a suspended state, a dissolved state, or a partially suspended and partially dissolved state is prepared.

In the present invention, in the reacting to prepare the precursor solution, during the reaction, the particle size and reaction rate of the suspended-state precursor is controlled by treatment with one or more of ultrasonic application, passage through a high-pressure homogenizer, mechanical grinding, or the particle size and reaction rate of the suspended-state precursor is controlled by controlling the concentration of the alkali metal-transfer catalyst radicals to induce nucleation and growth of the suspended-state precursor.

In the present invention, in the reacting to prepare the precursor solution, the particle size of the solid electrolyte precursor recovered from the precursor solution is controlled by addition of a dispersant, a surfactant, or both, during the reaction.

In the present invention, in the recovering of the alkali metal ion conductive chalcogenide-based solid electrolyte precursor in a powder form, the suspended-state precursor in the solution is separated and recovered by one or more methods selected from filtering, centrifugation, natural settling, spraying, and hydrocycloning, and the dissolved-state precursor or the partially suspended and partially dissolved-state precursor in the solution is recovered by one or more methods selected from heat drying, solvent displacement, and spray drying.

In the present invention, the heat treating is performed such that the alkali metal ion conductive chalcogenide-based solid electrolyte precursor in a powder form is heated or vacuum dried at a temperature in a range of from room temperature to 200° C. to remove the residual polar aprotic solvent or transfer catalyst, and is then crystallized at a temperature in a range of from 140° C. to 600° C. in an atmosphere of at least one of vacuum, inert gas, and hydrogen sulfide (H₂S) gas.

In the present invention, the alkali metal is at least one type selected from the group consisting of lithium (Li), sodium (Na), and potassium (K).

In the present invention, the transfer catalyst is at least one polycyclic aromatic hydrocarbons (PAHs) selected from the group consisting of naphthalene, acenaphthylene, acenaphthene, diphenyl, fluorene, phenanthrene, anthracene, fluoranthene, pyrene, benzo(a)anthracene, chrysene, benzo(k)fluoranthene, benzo(b)fluoranthene, benzo(a)pyrene, indeno(1,2,3-cd)pyrene, dibenz(a,h)anthracene, and benzo(g, h,i)perylene.

In the present invention, the chalcogen element is at least one selected from the group consisting of sulfur (S), selenium (Se), tellurium (Te), and mixtures thereof with oxygen (O).

In the present invention, the polar aprotic solvent is at least one type selected from the group consisting of an aliphatic mono-ether, an aliphatic di-ether, a cyclic ether, a poly ether, an aromatic ether, and an aliphatic ester.

To solve another technical problem, the present invention provides an alkali metal ion conductive chalcogenide-based solid electrolyte represented by Chemical Formula 1 shown below.

(A⁺)ₐ(Bⁿ⁺)_{b}(X²⁻)ₓ(Y⁻)_{y} [Chemical Formula 1]

In Chemical Formula 1, A is one or more elements among Li, Na, and K; B is one or more elements of Groups 2 through 15 of the periodic table; X is one or more elements among S, Se, and Te, or a mixture of the one or more elements and O; Y is one or more elements or compounds among F, Cl, Br, I, CN, OCN, SCN, and N₃; a+n*b−2*x−y=0; a>0, x>0; and at least one of b and y is a value that satisfies >0.

In the present invention, in Chemical Formula 1, A=Li; B═P; X═S; Y=one or more halogen elements among F, Cl, Br, and I; a=7−y, b=1, x=6−y, and 0.1≤y≤2; and an azirodite crystal structure of space group F-43m accounts for 50-100 wt %.

In order to solve a further technical problem, the present invention provides an all-solid-state battery including an alkali metal ion conductive chalcogenide-based solid electrolyte represented by Chemical Formula shown below.

(A⁺)ₐ(Bⁿ⁺)_{b}(X²⁻)ₓ(Y⁻)_{y} [Chemical Formula 1]

In Chemical Formula 1, A is one or more elements among Li, Na, and K; B is one or more elements of Groups 2 through 15 of the periodic table; X is one or more elements among S, Se, and Te, or a mixture of the one or more elements and O; Y is one or more elements or compounds among F, Cl, Br, I, CN, OCN, SCN, and N₃; a+n*b−2*x−y=0; a>0, x>0; and at least one of b and y is a value that satisfies >0.

In the present invention, in Chemical Formula 1, A=Li; B═P; X═S; Y=one or more halogen elements among F, Cl, Br, and I; a=7−y, b=1, x=6−y, and 0.1≤y≤2; and an azirodite crystal structure of space group F-43m accounts for 50-100 wt %.

### Advantageous Effects

In the alkali metal ion conductive chalcogenide-based solid electrolyte preparation method of the present, alkali metal ion conductive chalcogenide-based solid electrolyte raw materials including an alkali metal-containing material, a transfer catalyst that ionizes an alkali metal and transfer ions and electrons, a chalcogen element, and a compound of one or more elements of Groups 2 to 15 and 17 of the periodic table are stirred and reacted in a single solvent, which is a polar aprotic solvent, so that the alkali metal ion conductive chalcogenide-based solid electrolyte raw material can concurrently react with each other, resulting in synthesis of an alkali metal ion conductive chalcogenide-based solid electrolyte precursor in a suspended state, a dissolved state, or a partially suspended and partially dissolved state, and the precursor is recovered as a powder and heat-treated. Through the processes, a crystalline or glass-ceramic-structured alkali metal ion (Li⁺, Na⁺, K⁺) conductive chalcogenide-based solid electrolyte can be easily prepared without using an expensive, hard-to-store material such as Li₂S, Na₂S, or K₂S.

Furthermore, for the alkali metal-containing material that is to be reacted with a chalcogen element and a compound of one or more elements of Groups 2 to 15 and 17 of the periodic table in a polar aprotic solvent, the alkali metal can be used solely. Alternatively, the alkali metal may be reacted with a transfer catalyst in a polar aprotic solvent in advance to prepare an alkali metal-transfer catalyst radical solution, and this radical solution can be used for the subsequent reaction. The latter case has the advantage of reducing the time for dissolving and reacting the alkali metal.

In addition, in the reaction to prepare the precursor solution, the particle size and reaction rate of the suspended-state precursor can be controlled by physical powder grinding methods such as ultrasonic application, passage through a high-pressure homogenizer, and mechanical grinding. Alternatively, the particle size and reaction rate of the precursor can be controlled by adjusting the concentration of the alkali metal ion-transfer catalyst radicals to induce chemical nucleation and growth of the suspended-state precursor.

Furthermore, after recovering the alkali metal ion conductive chalcogenide-based solid electrolyte precursor in a powder form, the remaining solvent is recovered and reused in the first stage for the synthesis of the alkali metal ion conductive chalcogenide-based solid electrolyte by returning the solvent in a batchwise or continuous manner. Therefore, the present invention can reduce the preparation costs and can be favorably used for mass production.

### BRIEF DESCRIPTION OF THE DRAWINGS

FIG. 1 is a flowchart illustrating a method for preparing an alkali metal ion conductive chalcogenide-based solid electrolyte according to the present invention;

FIG. 2 is a diagram illustrating an exemplary preparation method for Li6PS5Cl electrolyte among alkali metal ion conductive chalcogenide-based solid electrolytes according to the present invention;

FIG. 3 is SEM photographs illustrating particle size control characteristics according to Examples 1 and 2;

FIG. 4 is a photograph illustrating color changes during synthesis reaction of Li6PS5Cl among alkali metal ion conductive chalcogenide-based solid electrolytes according to Example 1;

FIG. 5 is a graph illustrating an XRD pattern of Li6PS5Cl among alkali metal ion conductive chalcogenide-based solid electrolytes according to Example 1; and

FIG. 6 is a graph illustrating ion conductivity of Li6PS5Cl among alkali metal ion conductive chalcogenide-based solid electrolytes according to Example 1.

### DESCRIPTION OF THE EMBODIMENTS

Hereinafter, the present invention will be described in detail.

In one aspect, the present invention relates to an alkali metal ion conductive chalcogenide-based solid electrolyte. The alkali metal ion conductive chalcogenide-based solid electrolyte according to the present invention has a composition represented by Chemical Formula 1 below.

(A⁺)ₐ(Bⁿ⁺)_{b}(X²⁻)ₓ(Y⁻)_{y} [Chemical Formula 1].

In Chemical Formula 1, A is one or more elements among Li, Na, and K; B is one or more elements of Groups 2 through 15 of the periodic table; X is one or more elements among S, Se, and Te, or a mixture thereof with O; and Y is one or more elements or compounds among F, Cl, Br, I, CN, OCN, SCN, and N₃. Here, a+n*b−2*x−y=0; a>0, x>0; and at least one of b and y is a value that satisfies >0.

In addition, in Chemical Formula 1, A=Li; B═P; X═S; Y=one or more halogen elements among F, Cl, Br, and I; a=7−y, b=1, x=6−y, and 0.1≤y≤2; and an azirodite crystal structure of space group F-43m accounts for 50-100 wt %.

That is, in the present invention, the alkali metal ion conductive chalcogenide-based solid electrolyte has a composition of (A⁺)ₐ(Bⁿ⁺)_{b}(X²⁻)ₓ(Y⁻)_{y}. Therefore, the raw materials of the alkali metal ion conductive chalcogenide-based solid electrolyte use the alkali metal A and the chalcogenide X instead of conventional expensive materials such as A₂X(Li₂S, Na₂S, K₂S, Li₂Se, etc.).

Specifically, the composition of the alkali metal ion conductive chalcogenide-based solid electrolyte includes A, B, X, and Y such that a A-B—X—Y powder can be recovered. A refers to at least one alkali metal selected from the group consisting of lithium (Li), sodium (Na), and potassium (K). B refers to one or more elements belonging to Groups 2 through 15 of the periodic table, and the material that can serve as the source of B in the alkali metal ion conductive chalcogenide-based solid electrolyte may be one or more types selected from the group consisting of B, B—X, and B—Y. X refers to a chalcogen element such as sulfur (S), selenium (Se), or tellurium (Te) belong to Group 16 elements of the periodic table or refers to a mixture of such an element with oxygen (O). The material that can be a source of a chalcogen element for the alkali metal ion conductive chalcogenide-based solid electrolyte may be one or more types selected from the group consisting of X and B—X. In the case of oxygen (O) among the chalcogen elements, it is preferred to be present only as a mixture. Y may include to an element such as fluorine (F), chlorine (Cl), bromine (Br), or iodine (I) belonging to Group 17 of the periodic table, and a monovalent anion such as CN, OCN, SCN, or N₃, in which the material from which Y may be derived may be one or more selected from the group consisting of A-Y and B—Y.

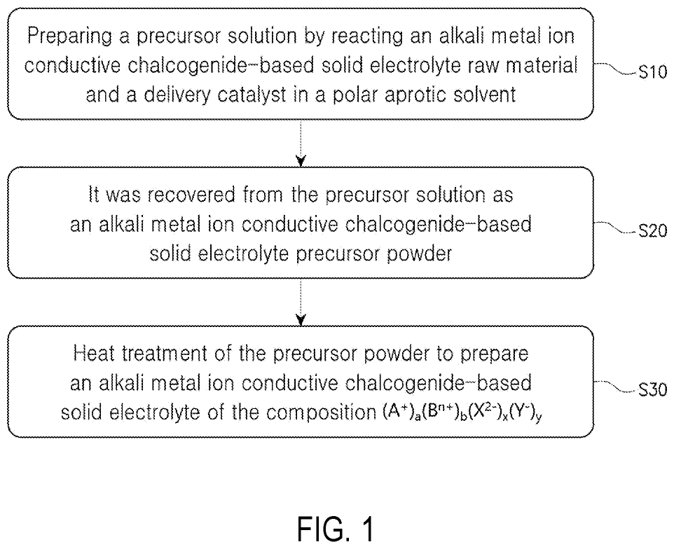

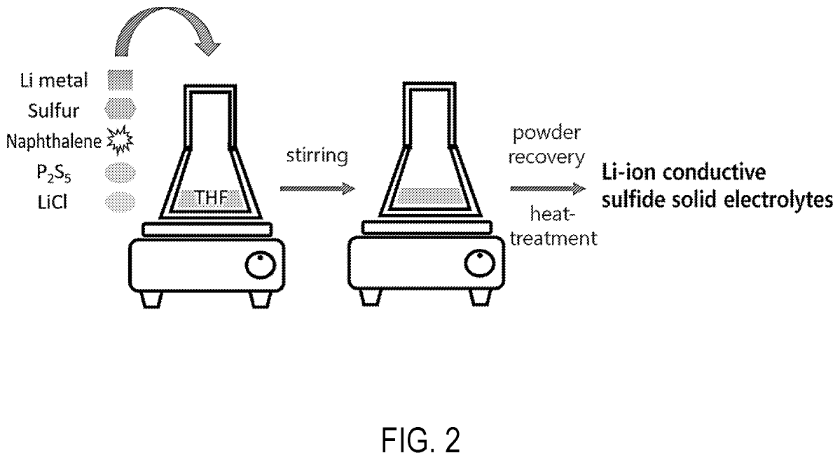

In another aspect, the present invention relates to a method of preparing an alkali metal ion conductive chalcogenide-based solid electrolyte. In this regard, FIG. 1 is a flowchart illustrating a method of preparing an alkali metal ion conductive chalcogenide-based solid electrolyte according to the present invention, and FIG. 2 is an exemplary flowchart illustrating a method of preparing Li₆PS₅Cl electrolyte among alkali metal ion conductive chalcogenide-based solid electrolytes according to the present invention.

Referring to FIGS. 1 and 2, the alkali metal ion conductive chalcogenide-based solid electrolyte preparation method according to the present invention includes: Step S10 of reacting, in a polar aprotic solvent, alkali metal ion conductive chalcogenide-based solid electrolyte raw materials including an alkali metal-containing material, a transfer catalyst that ionizes an alkali metal and transfers ions and electrons, a chalcogen element, a compound of one or more elements of Groups 2 to 15 and Group 17 of the periodic table, to prepare a precursor solution in which an alkali metal ion conductive chalcogenide-based solid electrolyte precursor is present in a suspended state, a dissolved state, or a partially suspended and partially dissolved state, via an alkali metal polychalcogenide produced by the transfer of the ions and electrons from the alkali metal-containing material to the chalcogen element; Step S20 of recovering the alkali metal ion conductive chalcogenide-based solid electrolyte precursor in a powder form from the precursor solution; and Step S30 of heat treating the alkali metal ion conductive chalcogenide-based solid electrolyte precursor in a powder form.

In Step S10, to prepare the alkali metal ion conductive chalcogenide-based solid electrolyte having the composition represented by Chemical Formula 1 shown above, the alkali metal ion conductive chalcogenide-based solid electrolyte raw materials including an alkali metal-containing material, a transfer catalyst that ionizes an alkali metal and transfers ions and electrons, a chalcogen element, and a compound of one or more elements belonging to Groups 2 through 15 and 17 of the periodic table, are reacted in a polar aprotic solvent. During the reaction, the ions and electrons are transferred to the chalcogen element from the alkali metal-containing material, thereby producing alkali metal polychalcogenides. Via the alkali metal polychalcogenides, a precursor solution in which an alkali metal ion conductive chalcogenide-based solid electrolyte precursor is present in a suspended state, a dissolved state, or a partially suspended and partially dissolved state is prepared.

As will be described below, the alkali metal-containing material may be one or more selected from the group consisting of an alkali metal, an alkali metal-transfer catalyst radical solution prepared by reacting an alkali metal with a transfer catalyst in a polar aprotic solvent, and a mixture thereof.

By using an alkali metal alone as the alkali metal-containing material, and reacting the alkali metal with the chalcogen element and the compound of one or more elements of the elements of Groups 2 to 15 and 17 of the periodic table in a polar aprotic solvent in a single step, during a period in which the alkali metal is dissolved, the remaining raw materials can be dissolved. Typically, alkali metals quickly dissolve at an initial stage, but the dissolution slows down over time, thereby taking up to 12 hours in total to completely dissolve in a polar aprotic solvent. Therefore, it is not desirable to use the alkali metal as it is in a mass production process.

To solve the problem, an alkali metal as the alkali metal-containing material and a transfer catalyst are preliminarily reacted in a polar aprotic solvent to obtain an alkali metal-transfer catalyst radical solution in advance. This radical solution will be added to and reacted with the reactants such as the chalcogen element and the compound of one or more elements of Groups 2 through 15 and 17 in a polar aprotic solvent. The use of the alkali metal-transfer catalyst solution in which the alkali metal is preliminarily dissolved overcomes the disadvantage of using the alkali metal as it is, the disadvantage of requiring approximately 12 hours to completely dissolve the alkali metal in a polar aprotic solvent.

When the reaction is carried out under a polar aprotic solvent, the particle size of the suspended-state precursor can be physically controlled by powder grinding, such as ultrasonic application, passing through a high-pressure homogenizer, or mechanical grinding. The particle size can be chemically controlled by controlling the concentration of the alkali metal ion-transfer catalyst radicals to induce nucleation and growth of the suspended-state precursor. That is, the particle size of the alkali metal ion conductive chalcogenide-based solid electrolyte can be controlled.

In the case of using an alkali metal as it is, when 33% of the alkali metal is dissolved, the remaining reactants will be added to be dissolved. As the alkali metal dissolves, it begins to form particles, which become larger and larger in size. The initially formed particles grow at a faster rate, and the gap between the particles increases over time. In order to overcome this disadvantage, ultrasonic application, passing through a high-pressure homogenizer, mechanical grinding, or the control of concentration of the alkali metal in the alkali metal-transfer catalyst radical solution is performed.

When reacting in a polar aprotic solvent, the alkali metal-transfer catalyst solution is instantly added to instantly increase the concentration of alkali metal, so that nuclei are instantaneously created in the solution, thereby controlling the growth of nuclei and even controlling the particle size. However, when the stirring for the reaction is continued, the particles may be continuously enlarged. When particles are generated, ultrasonic waves are applied to the reaction solution, or the reaction solution is passed through a high-pressure homogenizer or is subjected to mechanical milling, so that the particles can be pulverized. That is, the number of relatively small particles can be increased. In addition, particle size control as well as reaction rate control can be achieved by ultrasonic application, passage through a high-pressure homogenizer, or mechanical grinding as described above. In some cases, dispersants or surfactants may be added to control the reaction rate.

Preferably, in a state in which the alkali metal itself (for example, about 33% or less of the alkali metal ion conductive chalcogenide-based solid electrolyte raw materials), the chalcogen element, and the compound of one or more elements of Groups 2 through 15 and 17 of the periodic table are reacted in a polar aprotic solvent so that the alkali metal is completely dissolved, the alkali metal-transfer catalyst radical solution is instantaneously added to increase the number of seeds to speed up the reaction, and ultrasonic application can be used to control the seed size during the reaction. However, the order of addition of the alkali metal itself and the alkali metal-catalyzed radical solution is not particularly limited.

In the context of the present invention, the suspended state or suspension refers to a solution in which alkali metal ion conductive chalcogenide-based solid electrolyte precursors in powder or granular form are dispersed as undissolved. For Li6PS5Cl, a solid electrolyte precursor as a suspension is formed by mixing the raw materials, i.e., Li, S, P2S5, LiCl, with a transfer catalyst (for example, naphthalene) in THF. In this case, in order for the alkali metal ion conductive chalcogenide-based solid electrolyte precursor not to be dissolved but to be dispersed in a powder form in a solvent, the solvent is first added to a container such as a flask as shown in FIG. 2, and the alkali metal ion conductive chalcogenide-based solid electrolyte raw materials and the transfer catalyst are all added to the solvent contained in the container. Thus, a stirring reaction is performed at room temperature or, in the case of THF, at a temperature in a range from −108° C. to 66° C. That is, the stirring reaction can be performed at room temperature or at a temperature between the freezing and melting points of the solvent. Alternatively, the stirring reaction can be performed under a solvent heating condition using the vapor pressure of the solvent at high temperature and pressure.

The solvent used in the stirring reaction is preferably ethers that accelerate the action of the transfer catalyst, and one or more types selected from the group consisting of an aliphatic mono-ether, an aliphatic di-ether, a cyclic ether, a poly-ether, and an aromatic ether may be used. In addition, polar aprotic solvents such as aliphatic esters, which have a reduction potential lower than that of lithium metal, can be used.

The aliphatic mono-ether may be one or more of dimethyl ether, diethyl ether, methyl ethyl ether, thyl normal propyl ether, and methyl isopropyl. The aliphatic di-ether may be one or more of methylal and glycol dimethyl ether. Examples of cyclic ethers include one or more of tetrahydrofuran (THF), tetrahydropyran, and tetrahydrofuran. The polyether may be one or more of glycol formal, methyl glycerol formal, dimethylene pentaerythrite, and glycerol mono-formal methyl ether. The aromatic ether may be one or more of anisole, methylanisole, and dimethylanisole. The aliphatic monoester may be one or more of diethyl carbonate, dimethyl carbonate, ethyl methyl carbonate, methyl formate, methyl acetate, ethyl acetate, ethyl propionate, and ethyl butyrate.

A transfer catalyst can ionize alkali metals and transfer ions and electrons. The transfer catalyst is a transferring substance that receive alkali metal ions and electrons from an alkali metal and transfers them to a chalcogen element. Using an alkali metal polychalcogenide, which is produced by the transfer of ions and electrons from an alkali metal-containing material to a chalcogen element, a precursor solution in which an alkali metal ion-conductive chalcogenide-based solid electrolyte precursor is present in a suspended state, a dissolved state, or a partially suspended or partially dissolved state can be prepared.

That is, by sequentially forming a polychalcogenide of an alkali metal ion (for example, 2Li+S₈→Li₂S₈→Li₂S₆→Li₂S₄→Li₂S₂→Li₂S) to promote the reaction with a B compound (for example, P₂S₅) and a Y compound (for example, LiCl), an alkali metal ion conductive chalcogenide-based solid electrolyte precursor is synthesized as a suspension, a dissolution, or a combination thereof in a solvent.

This feature allows the transfer catalyst to act as an electron donor while a soluble polychalcogenide is formed by the process of 2A+2PAH+Xₙ→2A⁺PAH⁻+Xₙ→A₂Xₙ+2PAH. As the electron transfer reaction proceeds, the combining of B—X and A-Y compounds with A₂Xₙ chalcogenide is promoted (for example, P₂S₅→Li₂P₂S₆→Li₄P₃S₇→2Li₃PS₄), and when A is completely dissolved, the precursor of A-B—X—Y is produced.

The transfer catalysts that mediate the transfer of electrons between alkali metals and chalcogen elements may be polycyclic aromatic hydrocarbons (PAHs). As the polycyclic aromatic hydrocarbon (PAH), at least one selected from the group consisting of baphthalene, acenaphthylene, acenaphthene, diphenyl, fluorene, phenanthrene, anthracene, fluoranthene, pyrene, benzo(a)anthracene, chrysene, benzo(k)fluoranthene, benzo(b)fluoranthene, benzo(a)pyrene, indeno(1,2,3-cd)pyrene, dibenz(a,h)anthracene, and benzo(g,h,i)perylene may be used.

Among these, naphthalene is an aromatic hydrocarbon consisting of two benzene rings, having a strong carbon-hydrogen bond energy, and being easily oxidized. Therefore, naphthalene has the most stable structure among polycyclic aromatic hydrocarbons and is thus preferably used as the transfer catalyst.

As described above, since the transfer catalyst transfers ions and electrons from the alkali metal-containing material to the chalcogen element to generate an alkali metal polychalcogenide (for example, Li₂Sₙ, n is an integer in a range of 1 to 8), the polychalcogenide dissolves and disperses in the solution, and reacts and mixes with the B element, the Y element, or the compounds of the B and Y elements. As a result, in the precursor solution, an alkali metal ion conductive chalcogenide-based solid electrode precursor is present in a suspended state, a dissolved state, or a partially suspended and partially dissolved state.

Next, in Step S20, the alkali metal ion conductive chalcogenide-based solid electrolyte precursor in a powder form is recovered from the precursor solution.

In order to synthesize Li₆PS₅Cl among alkali metal ion conductive chalcogenide-based solid electrolytes, Li₃PS₄ is first synthesized as a suspension in a polar aprotic solvent (3Li₂S+P₂S₅→2Li₃PS₄), and Li₂S and LiCl are dissolved in ethanol, which is a polar aprotic solvent. Next, the solutions are mixed to prepare Li₆PS₅Cl precursor as dissolved, and the solvents are then evaporated to obtain powdery Li₆PS₅Cl. Alternatively, in a state in which the reaction product is partially suspended and partially dissolved in a polar aprotic solvent, the solvent is evaporated and removed to produce powdery Li₆PS₅Cl.

However, the solvent evaporation process using a rotary evaporator can lead to the production of coarse powder, the composition of the powder particles may become uneven due to the difference in solubility between salts during the precipitation process, and the solvents cannot be reused because it is difficult to separate the polar aprotic solvent and the polar protic solvent from each other after the evaporation. The use of dispersants to prevent powder coarsening may eventually lead to the problems that the dispersants with high boiling points remain as impurities on the surface of the alkali metal ion conductive chalcogenide-based solid electrolyte, thereby increasing electronic conductivity of the electrolyte, and the powder obtained in a lumpy state must undergo the cumbersome processes of heat treatment, grinding, and sieving.

On the other hand, the method of preparing the precursor in a suspended state according to the present invention allows the alkali metal ion conductive chalcogenide-based solid electrolyte precursor to be present in a suspended state, a dissolved state, or a combined state (partially suspended and partially dissolved) in the precursor solution. Therefore, only the solid electrolyte precursor powder can be recovered without an additional process of evaporating the solvent.

In particular, the suspended-state precursor (for example, Li₆PS₅Cl precursor) in the solution may be separated and recovered as a powdery precursor by one or more methods selected from natural settling, centrifugation, spraying, filtering, and hydrocycloning. The precursor in a dissolved state and the precursor in a partially suspended and partially dissolved state in the solution (for example, Li₇P₃S₁₁=Li₃PS₄(suspended)+Li₄P₂S₇(dissolved)) is separated and recovered as a powdery precursor by one or more methods selected from heat drying, solvent displacement, and spray drying.

The alkali metal ion conductive chalcogenide-based solid electrolyte powder obtained by the separation and recovery may have a particle size in the range of 0.1 to 10 μm. When the particle size of the powder is smaller than 0.1 μm, it is difficult to handle the powder, and it is difficult to secure high ionic conductivity due to the inter-particle interface between the surfaces with low crystallinity. On the other hand, when the particle size exceeds 10 μm, it is necessary to perform an additional grinding process.

After the alkali metal ion conductive chalcogenide-based solid electrolyte precursor powder is recovered from the precursor solution, the remaining solvent is recovered and returned to the first-stage process for the synthesis of the alkali metal ion conductive chalcogenide-based solid electrolyte for reuse. The solvent separated from the alkali metal ion conductive chalcogenide-based solid electrolyte precursor powder can be recycled with batchwise recovery in a container. Alternatively, it can be recycled with continuous recovery when the alkali metal ion conductive chalcogenide-based solid electrolyte raw materials are collectively added at one time and the alkali metal ion conductive chalcogenide-based solid electrolyte precursor is synthesized at the same time.

Finally, in Step S30, the alkali metal ion conductive chalcogenide-based solid electrolyte precursor powder is heat treated.

This step is a process of heat treating to crystallize the alkali metal ion conductive chalcogenide-based solid electrolyte precursor powder recovered from the precursor solution in which the precursor has been in a suspended state, a dissolved state, or a partially suspended and partially dissolved state. The alkali metal ion conductive chalcogenide-based solid electrolyte precursor powder maintains its particle size even through the heat treatment. Therefore, an additional grinding process is not necessary for the precursor powder.

The heat treatment involves a primary heating process in which the alkali metal ion conductive chalcogenide-based solid electrolyte precursor powder is heated or vacuum dried at a temperature in a range of from room temperature to 200° C. to remove the residual solvents or transfer catalysts and a secondary heating process in which the precursor powder is heated at a temperature in a range of 140° C. to 600° C. in an atmosphere of one or more of vacuum, inert gas, and hydrogen sulfide (H₂S) gas to crystallize the alkali metal ion conductive chalcogenide-based solid electrolyte.

In the primary heating process, vacuum conditions are created to prevent contact with oxygen or moisture, and then the alkali metal ion conductive chalcogenide-based solid electrolyte precursor powder is heated or vacuum dried at a temperature in a range of from room temperature to 200° C. to remove the residual solvents and transfer catalysts. When the heat treatment is performed below room temperature, it takes a long time to completely remove the residual transfer catalysts that may remain on the powder. When the temperature exceeds 200° C., the time to remove the residual solvent and the residual transfer catalyst can be shortened, but the evaporation of the components constituting the alkali metal ion conductive chalcogenide-based solid electrolyte may occur, and the crystallization of the alkali metal ion conductive chalcogenide-based solid electrolyte is not effective compared to the case where the heat treatment is performed at a lower temperature. Therefore, the primary heat treatment is performed in a temperature range of from room temperature to 200° C. for process efficiency. In the case of using THF as the solvent, for efficient removal of the residual solvent and the residual transfer catalyst and subsequent crystallization of the alkali metal ion conductive chalcogenide-based solid electrolyte, the primary heat treatment is preferably performed under a vacuum condition at a temperature in the range of from 60° C. to 120° C. With this primary heat treatment, it is possible to ensure that the obtained alkali metal ion conductive chalcogenide-based solid electrolyte is free of transfer catalyst-derived impurities.

In the secondary heat treatment process, the alkali metal ion conductive chalcogenide-based solid electrolyte powder that has undergone the primary heat treatment is heated at a temperature in the range of from 140° C. to 600° C., depending on the crystallization characteristics according to the composition, in an inert gas environment, a hydrogen sulfide (H₂S) gas environment, or a vacuum condition so that contact with oxygen or moisture is prevented, as in the case of the primary heat treatment. When the secondary heat treatment is performed at temperatures below 140° C., the alkali metal ion conductive chalcogenide-based solid electrolyte cannot be sufficiently crystallized. On the other hand, the secondary heat treatment at temperatures above 600° C. is undesirable because the high ionic conductivity crystalline structure of the alkali metal ion conductive chalcogenide-based solid electrolyte can be altered.

The alkali metal ion conductive chalcogenide-based solid electrolyte finally produced through the processes have the composition represented by Chemical Formula 1, (A⁺)ₐ(Bⁿ⁺)_{b}(X²⁻)ₓ(Y⁻)_{y}. Examples of compositions of alkali metal ion conductive chalcogenide-based solid electrolytes that can be synthesized by collectively adding the alkali metal ion conducting chalcogenide-based solid electrolyte raw materials and the transfer catalyst in a single step in a polar aprotic solvent are shown in Table 1 below. Various compositions can be easily synthesized also for Na and K.

TABLE 1

| Composition | Raw material |
|---|---|
| Li₃PS₄ | 3Li + 3/2 S + 1/2 P₂S₅ |
| Li₆PS₅Cl | 5Li + 5/2 S + 1/2 P₂S₅ + LiCl |
| Li₁₀GeP₂S₁₂ | 10Li + 5S + GeS₂ + P₂S₅ or 10Li + 7S + Ge + P₂S₅ |
| Li_{6.6}Si_{0.6}Sb_{0.4}S₅I | 5.6Li + 2.8S + 0.6SiS2 + 0.2Sb2S5 + LiI |
| Li₉P₃S₉O₃ | 9Li + 4.5S + 9/10 P₂S₅ + 3/5 P₂O₅ |

In the use of the preparation method of the alkali metal ion conductive chalcogenide-based solid electrolyte according to the present invention as described above, the alkali metal ion conductive chalcogenide-based solid electrolyte raw materials are collectively reacted at one time in a polar aprotic solvent by using a transfer catalyst, thereby producing an alkali metal ion conducting chalcogenide-based solid electrolyte precursor that is in a suspended state, a dissolved state, or a partially suspended and partially dissolved state in the solution. The alkali metal ion conductive chalcogenide-based solid electrolyte precursor in a suspended state or a dissolved state is separated and recovered as a powder, and the precursor powder is heat treated. The preparation method of the present invention has the advantage of continuously synthesizing alkali metal ion (LI+, Na+, K+) conductive chalcogenide-based solid electrolytes.

In another aspect, the present invention relates to an all-solid-state battery equipped with an alkali metal ion conductive chalcogenide-based solid electrolyte. Preferably, the all-solid-state battery includes a cathode, an anode, and a solid electrolyte layer disposed between the cathode and the anode, in which the solid electrolyte interposed between the cathode and the anode is characterized in that it is prepared by the preparation method described above.

As the cathode, any existing cathode can be used. Typically, the cathode is composed of a cathode active material, a solid electrolyte, a conductive material, and a binder, and a cathode current collector, in which the cathode current collector is made of stainless steel, aluminum, nickel, titanium, calcined carbon, or it is made of aluminum or stainless steel the surface of which is treated with carbon, nickel, titanium, silver, etc. that makes the surface highly conductive and not susceptible to chemical change.

Like the cathode, any existing anode can be used. Typically, the anode is composed of an anode active material, a solid electrolyte, a conductive material, a binder, and an anode current collector. Alternatively, the anode is a lithium metal anode or a lithium-free anode. The anode current collector is made of any material that is conductive and is not susceptible to chemical change. For example, the anode current collector is made of copper, stainless steel, aluminum, nickel, titanium, or calcined carbon. Alternatively, the anode current collector is made of copper or stainless steel the surface of which is treated with carbon, nickel, titanium, silver, etc., or is made of an aluminum-cadmium alloy.

That is, the all-solid-state battery includes a cathode, an anode, and a solid electrolyte layer. Specifically, the all-solid-state battery include the alkali metal ion conductive chalcogenide-based solid electrolyte of the present invention which has equivalent or superior physical properties to conventional alkali metal ion conductive chalcogenide-based solid electrolytes.

Hereinafter, examples of the present invention will be described in detail. The examples below are provided only to aid understanding of the present invention and thus should not be construed as limiting to the scope of the present invention.

### <Example 1> Preparation of Alkali Metal Ion Conductive Chalcogenide-Based Solid Electrolyte (Li₆PS₅Cl)

0.387 g of lithium metal, 0.897 g of sulfur, 1.242 g of P₂S₅, 0.474 g of LiCl, 0.716 g of naphthalene, and 27.6 ml of tetrahydrofuran were collectively added to a 100-ml flask in an argon atmosphere glovebox. The mixture was stirred with a magnetic bar for 14 h at 30° C. to prepare a precursor solution containing an alkali metal ion conductive chalcogenide-based solid electrolyte precursor.

The precursor solution was then centrifuged, and the precursor was recovered as a powder.

To remove the residual tetrahydrofuran and naphthalene adsorbed on the precursor, the powder was transferred to a crucible and heated under vacuum at 90° C. for 3 h. After the vacuum drying, the powder was heat treated at 550° C. for 8 h in an Ar flow environment to prepare an alkali metal ion conductive chalcogenide-based solid electrolyte.

### <Example 2> Preparation of Alkali Metal Ion Conductive Chalcogenide-Based Solid Electrolyte

A lithium metal-naphthalene radical solution was prepared by dissolving 0.215 g of lithium metal and 1.194 g of naphthalene in 10 ml of tetrahydrofuran. 0.215 g of lithium metal, 1.194 g of naphthalene, 1.493 g of sulfur, 2.071 g of P₂S₅, 0.790 g, and 40 ml of tetrahydrofuran were stirred together in a 100-ml flask in an argon gas atmosphere glovebox, to prepare a fully dissolved primary precursor solution (33% lithium content compared to the final composition). The previously prepared lithium metal-naphthalene radical solution was then added to the primary precursor solution while controlling the flow rate using a burette. The final mixture was stirred with a magnetic bar and applied with ultrasonic waves for 2 h at 30° C. Thus, a particle-phase secondary precursor solution (66% lithium content compared to the final composition) with particle sizes controlled was prepared. To this solution, 0.215 g of lithium metal and 1.194 g of naphthalene were added and stirred for 10 h to induce the growth of precursor particles and changes in composition, resulting in a tertiary precursor solution in which an alkali metal ion conductive chalcogenide-based solid electrolyte precursor was formed in a particulate phase (100% lithium content with respect to the final composition).

The precursor solution was then centrifuged, and the precursor was recovered as a powder.

To remove the residual tetrahydrofuran and naphthalene adsorbed on the precursor, the powder was transferred to a crucible and heated under vacuum at 90° C. for 3 h. After the vacuum drying, the powder was heat treated at 550° C. for 8 h in an Ar flow environment to prepare an alkali metal ion conductive chalcogenide-based solid electrolyte.

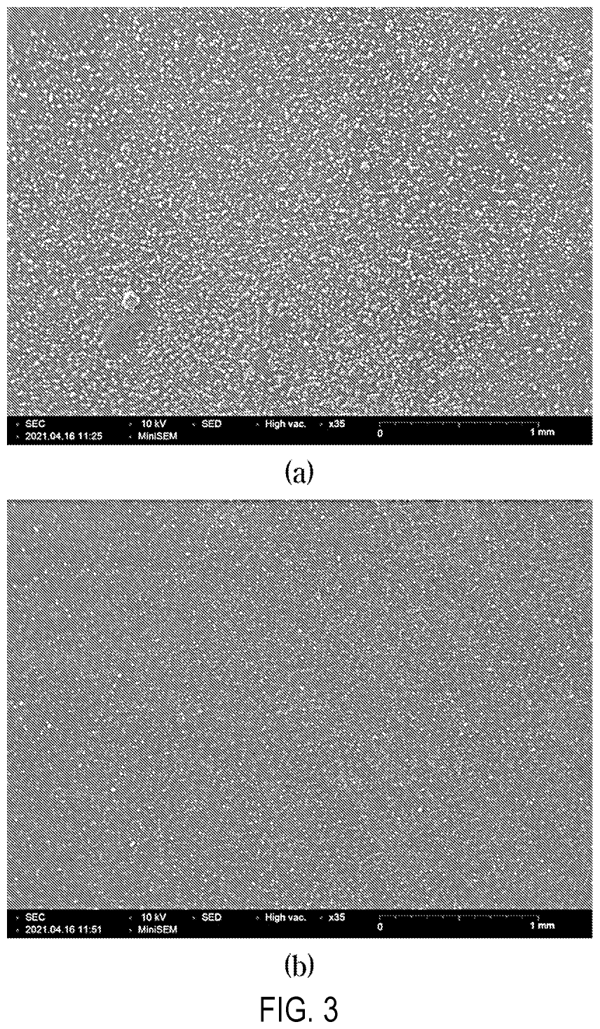

FIG. 3 is SEM photographs illustrating the particle size control characteristics according to Examples 1 and 2, in which FIG. 3(a) and FIG. 3(b) are 35×-magnified SEM photographs of alkali metal ion conductive chalcogenide-based solid electrolytes synthesized according to Examples 1 and 2, respectively, measured at 10 kV. Referring to FIGS. 3(a) and 3(b), it is seen that the particle size is controlled by the synthesis methods of Examples 1 and 2.

### <Experimental Example 1> Analysis for Identification of Sediment

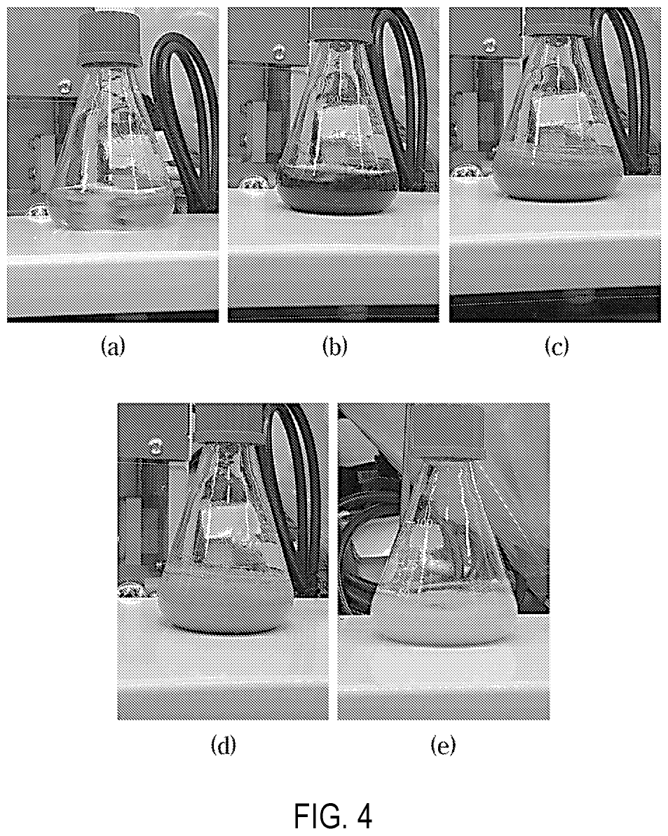

In this experimental example, a photograph per hour of a stirring reaction time in Example 1 was taken and observed. In this regard, FIG. 4 is a photographic representation of color changes during the synthesis reaction of an alkali metal ion conductive chalcogenide-based solid electrolyte according to Example 1. FIG. 4(a) is a photograph of a 100-ml flask containing 0.387 g of lithium metal, 0.897 g of sulfur, 1.242 g of P2S5, 0.474 g of LiCl, 0.716 g of naphthalene and 27 ml of tetrahydrofuran at the start of the stirring, and FIG. 4(b) is a photograph after 30 minutes of stirring, FIG. 4(c) shows a photograph after 1 hour of stirring, FIG. 4(d) shows a photograph after 6 hours of stirring, and FIG. 4(e) shows a photograph after 14 hours of stirring.

Referring to FIG. 4, the initial solution color was black as polysulfide was generated, then the color turned as the reaction with P₂S₅ gradually proceeds after 1 hour of stirring. After sufficient reaction, as shown in FIG. 4(e), i.e., after 14 hours of stirring, a solid electrolyte precursor in a suspended state was prepared.

### <Experimental Example 2> X-Ray Diffractive Spectroscopy

In this experimental example, the alkali metal ion conductive chalcogenide-based solid electrolyte prepared according to Example 1 was subjected to X-ray diffraction spectroscopy (XRD).

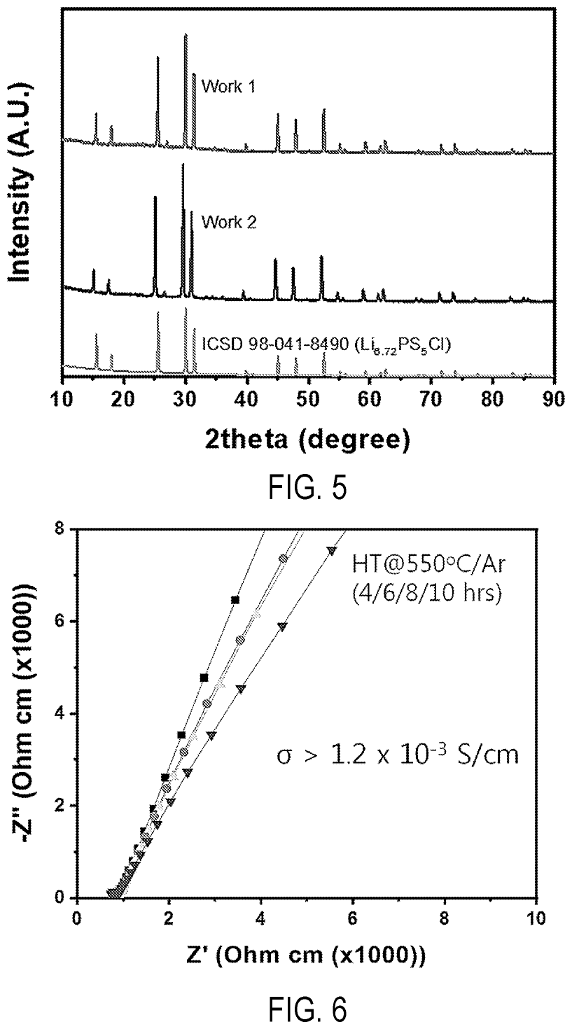

That is, X-ray diffraction analysis was performed on the alkali metal ion conductive chalcogenide-based solid electrolyte prepared as in Example 1, and the results are shown in FIG. 5. In this regard, FIG. 5 is a graphical representation of the XRD pattern of the alkali metal ion conductive chalcogenide-based solid electrolyte prepared according to Example 1.

Referring to FIG. 5, the alkali metal ion conductive chalcogenide-based solid electrolyte prepared according to Example 1 in which a stirring reaction was performed at 30° C. for 14 hours has major peaks at 15.5±0.5°, 18.0±0.5°, 25.5±0.5°, 30.0±0.5°, 31.5±0.5°, 40.0±0.5°, 45.5±0.5°, 48.0±0.5°, 53.0±0.5°, 55.0±0.5°, 56.5±0.5°, and 59.5±0.5° with a diffraction angle of 2θ. These peaks are identical to those of Li₆PS₅Cl having an azirodite-type crystal structure of space group F-43m, and the peaks attributable to impurities are rarely detected. Therefore, it is confirmed that the alkali metal ion conductive chalcogenide-based solid electrolyte prepared in Example 1 is an alkali metal ion conductive chalcogenide-based solid electrolyte with an azirodite crystal structure.

### <Experimental Example 3> Analysis for Ion Conductivity

In this experimental example, the alkali metal ion conductive chalcogenide-based solid electrolyte prepared according to Example 1 was analyzed for ionic conductivity.

That is, the alkali metal ion conductive chalcogenide-based solid electrolyte prepared according to Example 1 was 3-ton compression molded into a mold with a diameter of 1 cm to produce a molded body having a predetermined thickness and a predetermined diameter. Indium was attached to both surfaces of the fabricated molded body, and a test cell was assembled to analyze the ionic conductivity. A frequency sweep of 1×10⁶ to 0.1 Hz was performed with an alternating impedance analysis method to measure the impedance value. Thus, the ion conductivity value was obtained. In this regard, FIG. 6 is a graphical representation of the ion conductivity of the alkali metal ion conductive chalcogenide-based solid electrolyte prepared according to Example 1.

The ionic conductivity of the alkali metal ion conductive chalcogenide-based solid electrolyte is an important factor to determine the charging and discharging rate of the all-solid-state battery. Referring to FIG. 6, it is confirmed that the ionic conductivity of the alkali metal ion conductive chalcogenide-based solid electrolyte prepared according to Example 1 of the present invention has an excellent value of 1.2 mS/cm.

In summary, the present invention relates to a method for preparing an alkali metal ion conductive chalcogenide-based solid electrolyte by: reacting alkali metal ion conducting chalcogenide-based solid electrolyte raw materials including an alkali metal-containing material, a transfer catalyst that ionizes an alkali metal and transfers ions and electrons, a chalcogen element, and a compound of one or more elements of Groups 2 to 15 and 17 of the periodic table in a polar aprotic solvent, to prepare a precursor solution in which an alkali metal ion conductive chalcogenide-based solid electrolyte precursor is present in a suspended state, a dissolved state, or a partially suspended and partially dissolved state, via an alkali metal polychalcogenide produced by the transfer of the ions and electrons from the alkali metal-containing material to the chalcogen element; recovering the alkali metal ion conductive chalcogenide-based solid electrolyte precursor as a powder form the precursor solution; and heat treating the precursor powder to synthesize an alkali metal ion conductive chalcogenide-based solid electrolyte having a composition represented by Chemical Formula 1, (A⁺)ₐ(Bⁿ⁺)_{b}(X²⁻)ₓ(Y⁻)_{y}.

Alternatively, an alkali metal-transfer catalyst radical solution may be first prepared by reacting an alkali metal with a transfer catalyst, and then the radical solution is then reacted with a compound of a chalcogen element and a compound of one or more elements of Groups 2 to 15 and 17 of the periodic table in a polar aprotic solvent. In this case, the time required to dissolve and react the alkali metal can be reduced, and thus productivity can be increased.

In addition, the particle size of the finally obtained alkali metal ion conductive chalcogenide-based solid electrolyte precursor powder can be controlled by ultrasonic application, passage through a high-pressure homogenizer, or mechanical grinding, or by controlling the concentration of the alkali metal of the alkali metal-containing material to induce nucleation during the reaction to prepare the precursor solution.

After recovering the alkali metal ion conductive chalcogenide-based solid electrolyte precursor powder from the precursor solution, the remaining solvent is recovered and reused in the first stage for the synthesis of the alkali metal ion conductive chalcogenide-based solid electrolyte by returning the recovered solvent in a batchwise or continuous manner. Therefore, the preparation costs can be reduced, and the solid electrolyte can be mass produced.

Therefore, the alkali metal ion conductive chalcogenide-based solid electrolyte prepared according to the present invention can have a crystalline structure with high ionic conductivity, and is thus expected to improve the charging/discharging rate and power output rate of the all-solid-state battery.

The embodiments that have been described herein above are merely illustrative of the technical idea of the present invention, and thus various modifications, changes, alterations, substitutions, subtractions, and additions may also be made by those skilled in the art without departing from the gist of the present disclosure. The embodiments disclosed in the present disclosure are not intended to limit the scope of the present invention and the technical spirit of the present invention should not be construed as being limited to the embodiments. The protection scope of the present disclosure should be construed as defined in the following claims, and it is apparent that all technical ideas equivalent thereto fall within the scope of the present invention.

What is claimed is:

1. A method of preparing an alkali metal ion conductive chalcogenide-based solid electrolyte, the method comprising:
reacting, in a polar aprotic solvent, alkali metal ion conductive chalcogenide-based solid electrolyte raw materials including an alkali metal-containing material, a transfer catalyst ionizing an alkali metal and transferring alkali metal ions and electrons, a chalcogenide element, a compound of one or more elements of Groups 2 to 15 and Group 17 of the periodic table, to prepare a precursor solution in which an alkali metal ion conductive chalcogenide-based solid electrolyte precursor is present in a suspended state, a dissolved state, or a partially suspended and partially dissolved state, via an alkali metal polychalcogenide produced by the transfer of the ions and electrons from the alkali metal-containing material to the chalcogen element;
recovering the alkali metal ion conductive chalcogenide-based solid electrolyte precursor as a powder form from the precursor solution; and
heat treating the alkali metal ion conductive chalcogenide-based solid electrolyte precursor powder.

2. The method of claim 1, wherein the alkali metal-containing material is selected from the group consisting of an alkali metal, an alkali metal-transfer catalyst radical solution formed by reacting the alkali metal with the transfer catalyst in the polar aprotic solvent, and mixtures thereof.

3. The method of claim 1, the alkali metal ion conductive chalcogenide-based solid electrolyte is represented by Chemical Formula 1 shown below.
(A⁺)ₐ(Bⁿ⁺)_{b}(X²⁻)ₓ(Y⁻)_{y} [Chemical Formula 1]
wherein in Chemical Formula 1, A represents one or more elements among Li, Na, and K,
B is one or more elements of Groups 2 through 15 of the periodic table,
X is one or more elements among S, Se, and Te, or a mixture of the one or more elements and O,
Y is one or more elements or compounds among F, Cl, Br, I, CN, OCN, SCN, and N₃,
a+n*b−2*x−y=0,
a>0, x>0, and
at least one of b and y is a value that satisfies >0.

4. The method of claim 3, wherein in Chemical Formula 1,
A=Li, B═P, X═S, Y=one or more halogen elements selected from F, Cl, Br, and I,
a=7−y, b=1, x=6−y, and 0.1≤y≤2, and
an azirodite crystal structure of space group F-43m accounts for 50-100 wt %.

5. The method of claim 2, wherein when the precursor solution is prepared, alkali metal-transfer catalyst radicals produced by the reaction of the alkali metal-containing material and the transfer catalyst transfer the alkali metal ions and electrons to the chalcogen element to form an alkali metal polychalcogenide that is present in a dissolved state or a dispersed state, and the polychalcogenide reacts or mixes with the element B, the element Y, or a compound thereof, so that the precursor solution in which the alkali metal ion conductive chalcogenide-based solid electrolyte precursor is present in a suspended state, a dissolved state, or a partially suspended and partially dissolved state is prepared.

6. The method of claim 2, wherein in the reacting to prepare the precursor solution, during the reaction, the particle size and reaction rate of the suspended-state precursor is controlled by treatment with one or more of ultrasonic application, passage through a high-pressure homogenizer, mechanical grinding, or the particle size and reaction rate of the suspended-state precursor is controlled by controlling the concentration of the alkali metal-transfer catalyst radicals to induce nucleation and growth of the suspended-state precursor.

7. The method of claim 1, wherein in the reacting to prepare the precursor solution, during the reaction, a dispersion, a solution, or both are added so that the particle size of the solid electrolyte precursor recovered from the precursor solution is controlled.

8. The method of claim 1, wherein in the recovering of the alkali metal ion conductive chalcogenide-based solid electrolyte precursor as a powder, the suspended-state precursor in the solution is separated and recovered by one or more methods selected from filtering, centrifugation, natural settling, spraying, and hydrocycloning, and the dissolved-state precursor or the partially suspended and partially dissolved-state precursor in the solution is separated and recovered by one or more methods selected from heat drying, solvent displacement, and spray drying.

9. The method of claim 1, wherein in the heat treating, the alkali metal ion conductive chalcogenide-based solid electrolyte in a powder form is heated or vacuum dried at a temperature in a range of from room temperature to 200° C. to remove the residual polar aprotic solvent or transfer catalyst, and is then crystallized at a temperature in a range of from 140° C. to 600° C. in an atmosphere of at least one of vacuum, inert gas, and hydrogen sulfide (H₂S) gas.

10. The method of claim 1, wherein the alkali metal is at least one selected from the group consisting of lithium (Li), sodium (Na), and potassium (K).

11. The method of claim 1, wherein the transfer catalyst is at least one polycyclic aromatic hydrocarbon (PAH) selected from the group consisting of baphthalene, acenaphthylene, acenaphthene, diphenyl, fluorene, phenanthrene, anthracene, fluoranthene, pyrene, benzo(a)anthracene, chrysene, benzo(k)fluoranthene, benzo(b)fluoranthene, benzo(a)pyrene, indeno(1,2,3-cd)pyrene, dibenz(a,h)anthracene, and benzo(g,h,i)perylene.

12. The method of claim 1, wherein the chalcogen element is at least one selected from the group consisting of sulfur (S), selenium (Se), tellurium (Te), and mixtures thereof with oxygen (O).

13. The method of claim 1, wherein the polar aprotic solvent is at least one type selected from the group consisting of an aliphatic mono-ether, aliphatic di-ether, a cyclic ether, a poly ether, an aromatic ether, and an aliphatic ester.

14. An alkali metal ion conductive chalcogenide-based solid electrolyte represented by Chemical Formula 1 shown below:
(A⁺)ₐ(Bⁿ⁺)_{b}(X²⁻)ₓ(Y⁻)_{y} [Chemical Formula 1]
wherein in Chemical Formula 1,
A is one or more elements among Li, Na, and K,
B is one or more elements of Groups 2 through 15 of the periodic table,
X is one or more elements among S, Se, and Te, and mixtures thereof with O,
Y is one or more elements or compounds among F, Cl, Br, I, CN, OCN, SCN, and N₃,
a+n*b−2*x−y=0,
a>0, x>0, and
at least one of b and y is a value that satisfies >0.

15. The alkali metal ion conductive chalcogenide-based solid electrolyte of claim 14,
wherein in Chemical Formula 1, A=Li, B═P, X═S, Y=one or more halogen elements among F, Cl, Br, and I; a=7−y, b=1, x=6−y, and 0.1≤y≤2; and an azirodite crystal structure of space group F-43m accounts for 50-100 wt %.

16. An all-solid-state battery comprising an alkali metal ion conductive chalcogenide-based solid electrolyte represented by Chemical Formula 1 shown below:
(A⁺)ₐ(Bⁿ⁺)_{b}(X²⁻)ₓ(Y⁻)_{y} [Chemical Formula 1]
wherein in Chemical Formula 1,
A is one or more elements among Li, Na, and K,
B is one or more elements of Groups 2 through 15 of the periodic table,
X is one or more elements among S, Se, and Te, and mixtures thereof with O,
Y is one or more elements or compounds among F, Cl, Br, I, CN, OCN, SCN, and N₃,
a+n*b−2*x−y=0,
a>0, x>0, and
at least one of b and y is a value that satisfies >0.

17. The all-solid-state battery of claim 16, wherein in Chemical Formula 1, A=Li, B═P, X═S, Y=one or more halogen elements among F, Cl, Br, and I; a=7−y, b=1, x=6−y, and 0.1≤y≤2; and an azirodite crystal structure of space group F-43m accounts for 50-100 wt %.
